(19) United States
(12) Patent Application Publication
(10) Pub. No.: US 2008/0165195 A1
(43) Pub. Date: Jul. 10, 2008

(54) METHOD, APPARATUS, AND SOFTWARE FOR ANIMATED SELF-PORTRAITS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/837,673

(22) Filed: Aug. 13, 2007

Related U.S. Application Data
(60) Provisional application No. 60/879,192, filed on Jan. 6, 2007.

(51) Int. Cl. G06T 13/00

(52) U.S. Cl. 345/473

(57) ABSTRACT

A system is provided for generating animated self-portraits of a user that depict lifelike simulated behaviors under computer control. A processor controlled camera captures a plurality of self-portrait photographs of a user, each photograph depicting the user in one a plurality of different facial poses, for example different facial angles, eye-gaze directions, and facial expressions. An image database stores the photographs indexed with respect to the particular facial pose depicted. Processor implemented software routines access the image database such that a plurality of particular sequences of indexed photographs is selected and displayed in rapid succession. An animated self-portrait is therefore displayed that depicts a particular simulated facial behavior associated with each particular sequence. By sequencing the images appropriately, the animated self-portrait of a user is made to appear to look around in various directions, nod, yawn, speak or sing along with computer generated vocalizations, wink, blink, and vary facial expressions.

### RELATED APPLICATION DATA

This application claims priority to provisional application Ser. No. 60/879,192, filed Jan. 6, 2007, the disclosure of which is hereby incorporated by reference herein in its entirety. The present invention is related to co-pending U.S. patent application Ser. No. 11/535,423, by the present inventor, entitled “Digital Mirror System with Advanced Imaging Features and Hands-Free Control,” which was filed on Sep. 26, 2006 and which draws priority to U.S. Provisional Patent Ser. No. 60/737,877, filed Nov. 18, 2005; both of the aforementioned patent applications are hereby incorporated by reference in their entirety.

### FIELD OF THE APPLICATION

The present invention relates generally to an automated system, and associated method and software, for generating animated self-portraits of a user.

### BACKGROUND

Systems currently exist that allow a user to see an image of themselves upon a digital screen as captured by a digital camera. For example, U.S. Pat. No. 6,811,492, which is hereby incorporated by reference, discloses a system with a self-viewing mode. In addition, systems currently exist that enable a user to easily take a self portrait by looking at a real time digital image of themselves on a computer screen and then selectively take a picture. The systems generally require the user to manually frame the image as desired by moving his or her head around in relation to the camera and then manually press a button or manually engage a graphical user interface. The systems are generally intended for single self portraits and thus do not include automated methods for taking a set of photographs of a user that capture a plurality of specific facial angles, a plurality of specific eye directions, a plurality of different facial expressions, a plurality of different eye open and closed conditions, and/or a plurality of different phonic production facial images. Furthermore, such systems do not include a means of storing such systematically captured photographs in a database wherein such photographs are relationally indexed with respect to the specific facial angles, specific eye direction, specific facial expressions, specific eye conditions, and/or specific phonic productions they represent. Such systems do not include self-animation software that accesses such a database and produces an animated self-portrait that may be controlled under software moderation to simulate lifelike and/or humorous behaviors.

A system is therefore needed that enables novice users, even kids, to quickly and easily capture a systematic set of images of themselves and have the images stored and indexed in a database that supports the production of an animated self-portrait. There is also a need for control software that accesses the database of images and produces an animated self-portrait that is captivating to users, especially kids, by producing various computer controlled lifelike behaviors and/or humorous behaviors that are responsive to user input, responsive to changing environmental and/or computational conditions, and/or responsive to playing media files.

A portion of the hardware and software required for enabling a user to selectively and conveniently take a photograph of themselves using a digital camera and a digital screen is disclosed in co-pending patent application Ser. No. 11/535,423, by the present inventor, entitled “Digital Mirror System with Advanced Imaging Features and Hands-Free Control,” filed on Sep. 26, 2006, and which draws priority to U.S. Provisional Patent Ser. No. 60/737,877, filed Nov. 18, 2005. Both of the aforementioned patent applications are hereby incorporated by reference in their entirety.

### SUMMARY

Children often enjoy looking at themselves in the mirror, view video imagery of themselves, or otherwise see themselves from a far. Embodiments of the present invention provide an automated system by which a novice user, even a young child, can have a computer animated version of them created that is displayed under computer control and made to perform lifelike and/or humorous behaviors. The animated version of the user, referred to herein as an “animated self-portrait,” is comprised of an image database of specific facial poses of a user, with each specific facial pose being relationally associated with a facial pose index. The software routines access images from the facial pose database, displaying them in rapid temporal sequence, each in a co-located manner, with the sequence carefully controlled so as to create a stop motion animation illusion that the user is an animated character. A variety of sequences are performed such that by sequencing the facial pose images of the user in specific ways, a variety of simulated lifelike behaviors may be performed by the animated self portrait The image database comprises facial photographs of the user from a plurality of facial angles, with a plurality of different eyes-gaze directions, and with a plurality of different facial expressions, with each image being relationally associated with the unique facial angle, eyes gaze direction, and/or facial expression. The software routines are designed to access the database and display a temporal sequence of rapidly changing images. For example, by sequencing a rapid succession of images appropriately, the animated self-portrait of the user can be made to perform each of variety of simulated facial behaviors, such as move his or her head smoothly around to different angles, move his or her gaze smoothly around to different locations, vary his or her expression over time, and/or open-and-close his or her mouth to make the appearance of simulated vocalizations, even blink.

In some embodiments, the appearance of simulated vocalizations is made to correspond with the audio output of computer generated and/or digitized vocalizations. In such a way the animated self portrait of the user can be made to appear as an animated character that looks about, changes facial expressions, and talks. In some embodiments the animated self-portrait of the user is made to talk with his or her own voice. In other embodiments the animated self-portrait of the user is made to talk with humorous different voices, for example the voices of cartoon characters. In some embodiments the animated self-portrait is controlled so as to appear as though it is singing, for example being time synchronized with a stored digital music file of a popular song. In this way a computer animated version of a users own face may be generated upon his or her computer screen that is made to appear to talk, sing, tell jokes, or otherwise come to life. In some embodiments the animated self-portrait is made to blink and/or wink by sequencing through images depicting appropriate opened and closed eye conditions. In some embodiments, status updates are reported by the computer using the animated self-portrait correlated with synthesized or stored verbalization audio. In these ways, an animated self-portrait may be produced that depict lifelike and/or humorous behaviors that appear responsive to user input, to changing environmental and/or computational conditions, and/or to playing media files.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates an example system configuration according to an embodiment of the present invention;

FIG. 2 illustrates an alternate system configuration that enables the capture of facial images from a more realistic frontal perspective;

FIGS. 3B, 3B, 4B, 4B, 5A, 5B, 6A, 6B, 7A, and 7B illustrate exemplary self-portrait image databases according to an embodiment of the invention;

FIG. 8 illustrates a monitor having an embedded digital camera and a display screen area according to an embodiment of the invention;

FIG. 9 illustrates eye gaze markers according to an embodiment of the invention;

FIG. 10 illustrates automated head direction targets according to an embodiment of the invention;

FIG. 11A illustrates an example of how the display screen may appear at a particular instant during real-time gaze following according to an embodiment of the invention; and

FIG. 11B illustrates an example of the mathematical mapping between vector angles and eye pose indexes according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention provide an automated system by which a user can have a computer-animated version of them created that is displayed under computer control and made to perform lifelike and/or humorous behaviors. The animated version of the user, referred to herein as an “animated self-portrait,” is comprised of an image database of specific facial poses of a user, each specific facial pose being relationally associated with a facial pose index. The software routines access images from the facial pose database, displaying them in rapid temporal sequence, each in a co-located manner, the sequence being carefully controlled so as to create a stop motion animation illusion that the user is an animated character. A variety of sequences are performed such that by sequencing the facial pose images of the user in specific ways, a variety of simulated lifelike behaviors may be performed by the animated self portrait The image database comprises facial photographs of the user from a plurality of facial angles, with a plurality of different eyes-gaze directions, and with a plurality of different facial expressions, each image being relationally associated with the unique facial angle, eyes gaze direction, and/or facial expression.

The software routines are designed to access the database and display a temporal sequence of rapidly changing images. For example, by sequencing the images appropriately, the animated self-portrait of the user can be made to move his or her head smoothly around to different angles, move his or her gaze smoothly around to different locations, vary his or her expression over time, and/or open-and-close his or her mouth to make the appearance of simulated vocalizations, even blink. In some embodiments the appearance of simulated vocalizations is made to correspond with the audio output of computer generated and/or digitized vocalizations. In such a way the user can be made to appear as an animated character that looks about, changes facial expressions, and talks. In some embodiments the user is made to talk with his or her own voice. In other embodiments the user is made to talk with humorous different voices, for example the voices of cartoon characters. In some embodiments the user-animated face is made to appear as though it is singing, for example being time synchronized with a stored digital music file of a popular song. In this way a computer animated version of a users own face may be generated upon his or her computer screen that is made to appear to talk, sing, tell jokes, or otherwise come to life.

In some embodiments the user is made to blink and/or wink by sequencing through images depicting appropriate opened and closed eye conditions. In some embodiments, status updates are reported by the computer using the animated self-portrait correlated with synthesized or stored verbalization audio. In these ways, animated self-portrait may be produced that depict lifelike and/or humorous behaviors that appear responsive to user input, to changing environmental and/or computational conditions, and/or to playing media files.

Embodiments of the present invention provide methods, apparatus, and computer program products that enables the creation and control of an animated self-portrait upon a computer screen. More specifically, embodiments of the present invention provide an automated method of capturing a plurality of facial images of a user, each corresponding with a particular facial pose of the user, storing the facial images in an indexed database, accessing the database under computer control, and displaying time-sequenced images that are accessed from the database in a controlled manner so as to create an animated self-portrait of the user that appears to perform lifelike behaviors. In this way, an animated photorealistic depiction of the user may be displayed upon a computer screen that appears to look at about, turn his or her head, nod, wink, blink, talk, smile, frown, laugh, yawn, or otherwise perform lifelike facial behaviors under computer control. The animated version of the user, referred to herein as an animated self-portrait, is thus comprised of an image database of specific facial poses of a user, each specific facial pose being relationally associated with a facial pose index.

The software routines access images from the facial pose database, displaying them in rapid temporal sequence, each in a co-located manner, the sequence being carefully controlled so as to create a stop motion animation illusion that the user is an animated character. A variety of sequences are performed such that by sequencing the facial pose images of the user in specific ways, a variety of simulated lifelike behaviors may be performed by the animated self portrait The image database comprises facial photographs of the user from a plurality of facial angles, with a plurality of different eyes-gaze directions, and with a plurality of different facial expressions, each image being relationally associated with the unique facial angle, eyes gaze direction, and/or facial expression. The software routines are designed to access the database and display a temporal sequence of rapidly changing images. For example, by sequencing the images appropriately, the animated self-portrait of the user can be made to move his or her head smoothly around to different angles, move his or her gaze smoothly around to different locations, vary his or her expression over time, and/or open-and-close his or her mouth to make the appearance of simulated vocalizations, even blink. In some embodiments the appearance of simulated vocalizations is made to correspond with the audio output of computer generated and/or digitized vocalizations.

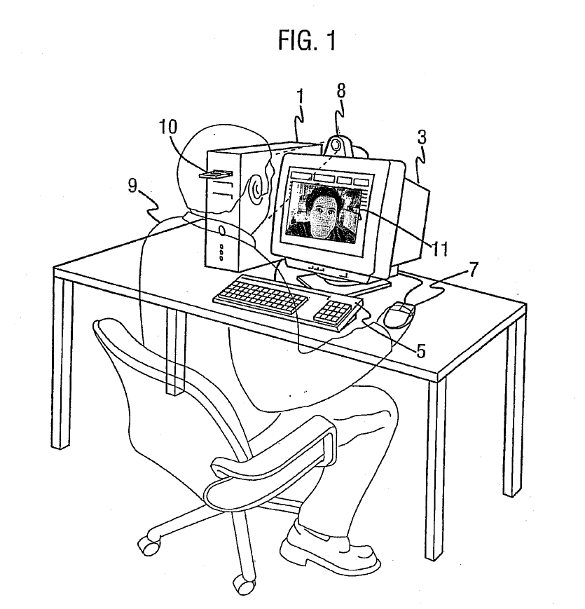

FIG. 1 illustrates an example system configuration according to an embodiment of the present invention. As shown, a user 9 is sitting before an electronic display 3, which in this case is a computer monitor sitting upon a desk. The electronic display 3 in this example is a desktop system, but those skilled in the art would readily appreciate that other electronic displays such as the displays associated with handheld devices including, but not limited to, e-books, Personal Digital Assistants (“PDAs”), cell phones, wrist watches, portable media players, and portable gaming systems could be employed instead. The electronic display 3 is driven by a personal computer 1 to run software, display images, and store photographs. The electronic display 3 is coupled to a digital camera 8, which is in processing communication with personal computer 1. The camera 8 is positioned such that it can capture frontal facial images of user 9 when user 9 is sitting before display screen 3. The frontal image of user 9 may be displayed in real time upon display screen 3, for example as shown in display window 11, thereby enabling user 9 to see an image of himself or herself when sitting before the screen 3. A user interface 7, which in this case is a mouse, enables the user to interact with software running upon computer 1. The user interface 7 may also include other hardware and software elements, such as voice recognitions hardware and software, touch screen hardware and software, and/or other means for users to input commands and data. Also shown is a keyboard 5 that may be used for entering commands and data. Using such user interface 7, a user may selectively take self-portrait photographs of himself or herself and store them in memory.

Embodiments of the present invention provide an automated method by which a plurality of self portrait photographs may be captured, stored in memory, and indexed by relational identifiers such that a self-portrait image database is created which comprises a database of facial photographs of the user as the user is enacting a variety of different facial poses. Each image is indexed to the specific facial pose that the user was instructed to perform upon capturing the image. In this way, the self-portrait image database includes images of the user from a plurality of different facial angles, with a plurality of different eyes-gaze directions, a plurality of different open and close eye conditions, a plurality of different open and close mouth conditions, and/or with a plurality of different facial expressions. Each image is relationally associated with the unique facial angle, eyes gaze direction, open and closed eye conditions, open and close mouth condition, and/or facial expression that it depicts. Furthermore, animated-portrait software routines are designed to access the database and display a temporal sequence of rapidly changing images, each in a co-located matter, selected such that the user appears as an animated character that performs life-like and/or humorous behaviors. For example, by sequencing the images appropriately and displaying them in rapid succession, the animated character of the user can be made to move his or her head smoothly around to different angles, move his or her gaze smoothly around to different locations, vary his or her facial expression over time, and/or open-and-close his or her mouth to make the appearance of simulated vocalizations, and/or open and close his or her eyes to make the appearance of simulated blinks and/or wink. In some embodiments the appearance of simulated vocalizations is made to correspond with the audio output of computer generated and/or digitized vocalizations. In such a way the user's animated self-portrait can be made to appear as an life-like computer controlled character that performs simulated facial behaviors, for example looks about, changes facial expressions, blinks, winks, nods, shakes his or her head, and talks.

In some embodiments the animated self-portrait is made to look in the direction of the cursor as it moves about the screen in real time, varying the facial direction and/or eye gaze direction in a manner that corresponds approximately with the animated self-portrait appearing to look towards the current cursor location on the screen. In some embodiments the animated self-portrait is made to look in the direction of a person detected within the imagery captured by camera 8. In this way, when a user sits before the screen 3, the animated self-portrait may be made to look in the approximate general direction of the user as he or she is captured by camera 8. The animated self-portrait makes simulated eye contact with the user. In such embodiments the direction at which the animated self-portrait looks is dependent upon the face location of the user 9 sitting before screen 3, the face location being determined by face detection methods known the current art. Thus, the animated self-portrait may be made to look towards a current cursor location, towards a current user's face as he or she sits before the screen, and/or towards other on screen or off screen events. For example, when a window pops up or some other graphical event occurs upon the screen, the animated self-portrait may be made to look in that approximate direction.

In some embodiments, the animated self-portrait of the user is made to talk with his or her own voice. In other embodiments the user is made to talk with humorous different voices, for example the voices of cartoon characters. In some embodiments the user animated face is made to appear as though it is singing, for example by being time synchronized with a stored digital music file of a popular song. In this way, a computer animated version of a user's own face may be generated upon a computer screen that is made to appear to talk, sing, tell jokes, or otherwise come to life. In some embodiments, the user is made to blink and/or wink by sequencing through images depicting appropriate opened and closed eye conditions. In some embodiments, status updates are reported by the computer using the animated self-portrait correlated with synthesized or stored verbalization audio. In these ways, an animated self-portrait may be produced that depict lifelike and/or humorous behaviors that appear responsive to user input, to changing environmental and/or computational conditions, and/or to playing media files.

Although FIG. 1 illustrates a desktop computing system for use in an embodiment of the present invention, it should be appreciated that a portable computing system may also be used so long as it has a camera mounted such that a self-portrait image may be captured while a user views a display screen.

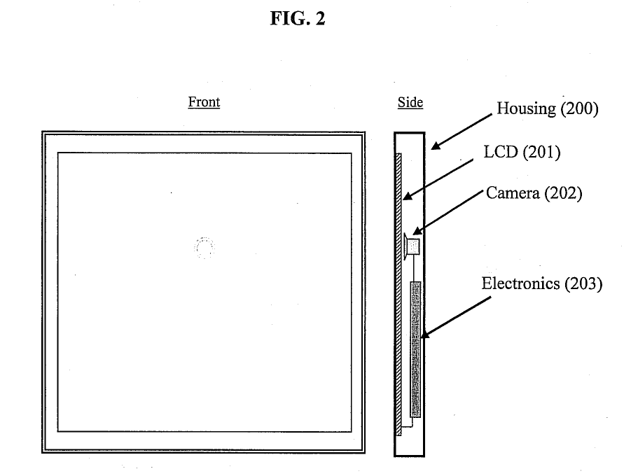

FIG. 2 illustrates an alternate system configuration that enables the capture of facial images from a more realistic frontal perspective. Unlike FIG. 1, where the camera is mounted above the display screen, FIG. 2 shows an embodiment where the camera is mounted within the area of the display screen so as to capture a facial image of a user from a more frontal and realistic perspective. Ideally, the camera is positioned such that the image is taken from a vantage point that is centered horizontally with respect to the display screen and at an elevation vertically that generally corresponds with a user's typical eye level. In this way, the user is looking straight at the camera when standing centered before the digital display screen. A number of different methods and/or technologies may be employed to achieve placement of a camera such that the image captured is from this centrally located area upon the display screen. In some embodiments, a small region of active screen area is removed to allow the camera to capture an image through the screen surface. This region of removed screen will generally appear as a blacked-out portion of the image. Various configurations of lenses, mirrors, and/or fiber optics can be used to enable flexibility in camera hardware positioning with respect to the small non-active portion of the screen.

Some embodiments of the present invention can be configured to capture camera imagery through the display screen without having the small dead region mentioned above.

This is generally achieved by using a display technology that is transparent during a portion of each display cycle. Referring specifically to the embodiment of FIG. 2, a camera 202 is positioned behind the display screen 201 and captures images through an active area of the screen during off-cycles when the camera imagery is not displayed. An LCD display screen is particularly well suited for such an embodiment because an LCD is generally transparent when not activated. Because LCD display screens are generally controlled through a rapid sequence of active and non-active cycling, the camera 202 may be positioned in the present invention such it collects image data through an LCD display screen 201 during the off-cycles when the LCD is not displaying an image. In some such embodiments, the camera 202 is pulsed at the same rate as the LCD display, but out of phase such that the camera 202 is operative to record images through the LCD when the LCD is transparent. Also shown in FIG. 2 are the control and drive electronics 203 for controlling the camera, controlling the display, and coordinating the timing of the interlacing of camera image capture and display of imagery upon the screen. In general, electronics 203 includes a processor that runs software routines, said software routines coordinating the timing of camera image capture and display cycles as described above such that the camera collects images during the off-cycles between image displays. Also shown in FIG. 2 is a housing 200, which holds the electronics, camera, display, and other components. The electronics may include a computer processor for running the animated self-portrait software routines, a memory for storing the self-portrait image database, and a user interface for enabling a user to interact with the software.

With respect to the Self-Portrait Image Database, a plurality of facial photographs of the user are captured and stored in memory, each relationally indexed. The database is comprised such that it contains a plurality of facial photographs of the user from a plurality of different facial angles, a plurality of different eyes-gaze directions, a plurality of different open and close eye conditions, a plurality of different open and close mouth conditions, and/or with a plurality of different facial expressions, each image being relationally associated with the unique facial angle, eyes gaze direction, open and close eye condition, open and close mouth condition, and/or facial expression that it depicts.

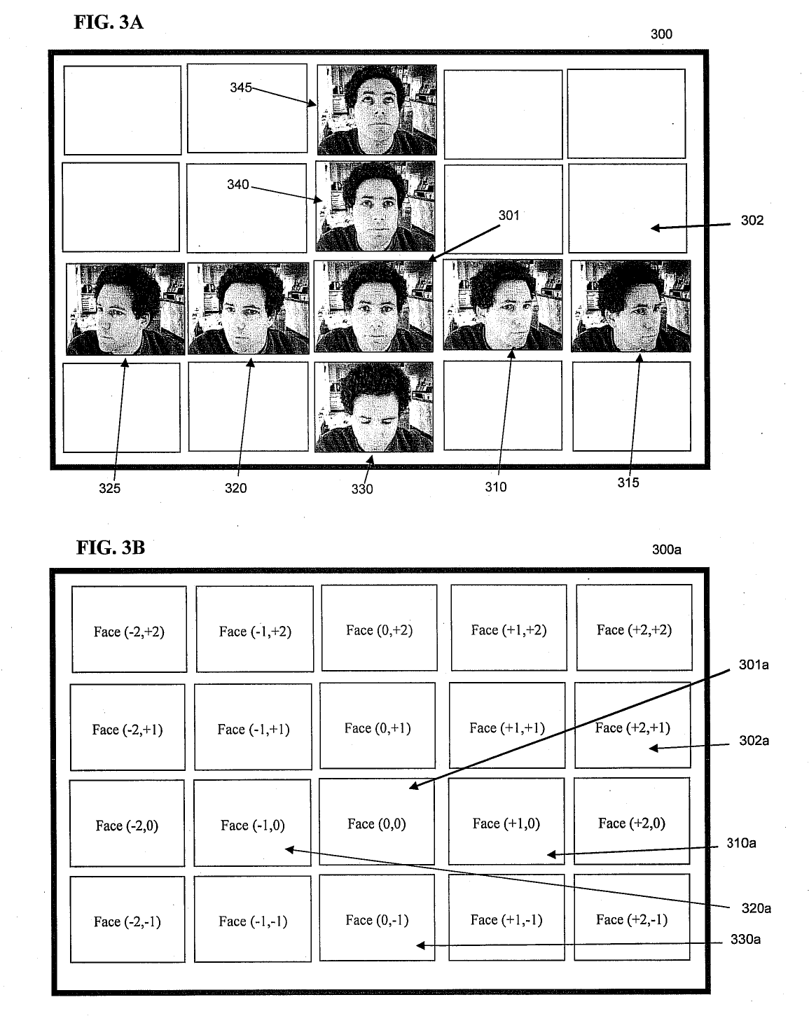

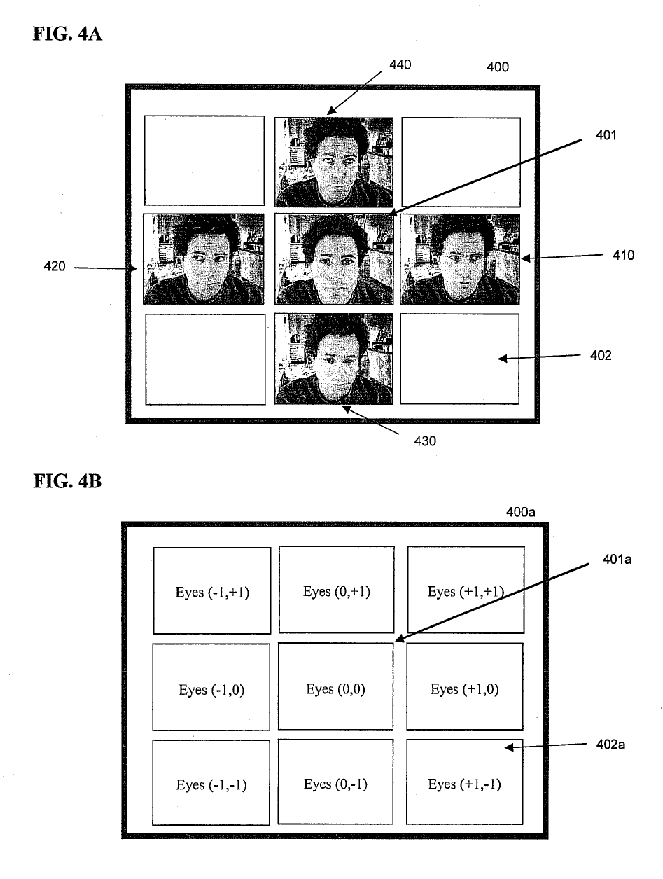

FIGS. 3B, 3B, 4B, 4B, 5A, 5B, 6A, 6B, 7A, and 7B illustrate exemplary self-portrait image databases according to an embodiment of the invention. For example, FIG. 4A shows a plurality of images stored in the database, each depicting a different eye gaze direction of the user. FIG. 4B shows the corresponding relational indexes that point at each of the plurality of images, enabling the animated self-portrait software routines to access specific eye gaze direction images at appropriate times.

Referring to FIG. 3A, a plurality of images stored in the database, each depicting a different facial direction of the user. For example, image 301 shows the user with a frontal facial direction (i.e., the user is looking approximately directly forward). Image 310 shows the user with his face turned slightly to the right, image 315 shows the user with his face turned a bit more to the right. Similarly, image 320 shows the user with his face turned slightly to the left and image 325 shows the user with his face turned a bit more to the left. Similarly image 330 shows the user with his face turned slightly downward. Also shown in FIG. 3A are images of the user with his face turned slightly upward 340 and a bit more upward 345. Additional photographs could be stored in the database, depicting further variations of left-right and up-down head turning. For example, an image could be stored as image 302 depicting the user with his head turned slightly upward and turned to the left. In this way a set systematic set of head direction variations can be stored in memory as a plurality of differing facial images.

FIG. 3B shows the corresponding relational indexes that point at each of the plurality of images, enabling the animated self-portrait software routines to access specific facial direction images at appropriate times. For example, the index shown at 301a corresponds to the image 301. This is the directly frontal facial image of the user. In this particular indexing convention, each image is indexed with an identifier “FACE” and two variables, the first variable indicating an amount of left-right facial turn, the second variable indicating the amount of up-down facial turn. Because image 301 corresponds with no left-right facial turn and no up-down facial turn, both of these variables are set to 0 in the index. Thus, as shown as 301a, the image 301 is indexed as FACE (0,0) which indicates through the indexing convention that the image is of the user's face aimed directly forward (i.e., with no facial turn in either direction).

Following the same convention, the index shown at 310a corresponds to the image 310. This is a facial image of the user with his head turned slightly towards the right. Again, in this indexing convention, each image is indexed with an identifier “FACE” and two variables, the first variable indicating an amount of left-right facial turn, the second variable indicating the amount of up-down facial turn. Because image 310 corresponds with the face turned slightly to the right, the first variable is set to +1. Because this image corresponds to no up-down facial turn, the second variable is set to 0. Thus, as shown as 310a, the image 310 is indexed as FACE (+1,0) which indicates through the indexing convention that the image is of the user's face aimed slightly to the right, with no up-down tilt.

Following the same convention, the index shown at 320a corresponds to the image 320. This is a facial image of the user with his head turned slightly towards the left. Again, in this indexing convention, each image is indexed with an identifier “FACE” and two variables, the first variable indicating an amount of left-right facial turn, the second variable indicating the amount of up-down facial turn. Because image 320 corresponds with the face turned slightly to the left, the first variable is set to −1. Because this image corresponds to no up-down facial turn, the second variable is set to 0. Thus as shown as 320a, the image 320 is indexed as FACE (−1,0) which indicates through the indexing convention that the image is of the user's face aimed slightly to the left, with no up-down tilt.

Following the same convention, the index shown at 330a corresponds to the image 330. This is a facial image of the user with his head turned slightly downward. Again, in this indexing convention, each image is indexed with an identifier “FACE” and two variables, the first variable indicating an amount of left-right facial turn, the second variable indicating the amount of up-down facial turn. Because image 330 corresponds with the face with no left-right turn, the first variable is set to 0. Because image 330 corresponds with the face turned slightly down, the second variable is set to −1. Thus, as shown as 330a, the image 330 is indexed as FACE (0,−1) which indicates through the indexing convention that the image is of the user's face aimed downward, with no up-down tilt.

Using this convention, a full range of facial images may be captured and stored for a user, each indexed with respect to the amount of left-right facial tilt and the amount of up-down facial tilt. This indexing convention enables the software routines of the present invention to easily access the facial self-portrait image database and access appropriate images for animating the character to turn his or her head in a particular direction. For example, to access an image of the user looking substantially upward, the animated self portrait software routines need simply to set the up-down variable to +2 and the left-right variable to 0, thus accessing image FACE (0, +2). This can be seen through the one to one correspondence between images and indexes represented by FIGS. 3A and 3B.

Referring to FIG. 4A, a plurality of images stored in the database, each of which depict a different eye direction of the user. For example, image 401 shows the user with a frontal face direction and a frontal eye gaze direction (i.e., the user is facing approximately directly forward and gazing approximately directly forward). Image 410 shows the user with a frontal face direction and his eyes shifted towards the right of the screen. Image 420 shows the user a frontal face direction and with his eyes shifted towards the left of the screen. Similarly, image 430 shows the user with a frontal face direction and his eyes shifted downward. Similarly, image 440 shows the user a frontal face direction and with his eyes shifted upward. Additional photographs could be stored in the database, depicting further variations of left-right and up-down eye shifting. For example, an image could be stored at 402 depicting the user with his head aimed forward and his eyes shifted downward and to the right side of the screen. In this way a set systematic set of eye gaze direction variations can be stored in memory as a plurality of differing facial images, each with a frontal face direction.

FIG. 4B shows the corresponding relational indexes that point at each of the plurality of images, enabling the animated self-portrait software routines to access specific eye gaze direction images at appropriate times. For example, the index shown at 401a corresponds to the image 401. This is the directly frontal facial image of the user with the directly frontal eye gaze. In this particular indexing convention, each image is indexed with an identifier “Eyes” and two variables, the first variable indicating an amount of left-right gaze shift, the second variable indicating the amount of up-down gaze shift. Because image 401 corresponds with no left-right gaze shift and no up-down gaze shift, both of these variables are set to 0 in the index. Thus, as shown as 401a, the image 401 is indexed as Eyes (0,0) which indicates through the indexing convention that the image is of the user's face aimed directly forward and his eyes directly forward.

Following this same two variable convention, the corresponding relational index is shown in the boxes of FIG. 4B that correlate to the images of FIG. 4A. In this way, the image 410, which shows the user with a frontal face direction and his eyes shifted towards the right of the screen, correlates with index Eyes (+1,0). Image 420, which shows the user a frontal face direction and with his eyes shifted towards the left of the screen, correlates with index Eyes (−1,0). Similarly, image 430, which shows the user with a frontal face direction and his eyes shifted downward, correlates with index Eyes (0,−1). Similarly, image 440 shows the user a frontal face direction and with his eyes shifted upward correlates with index Eyes (0,+1). Additional photographs could be stored in the database, depicting further variations of left-right and up-down eye shifting. For example, an image could be stored at 402 depicting the user with his head aimed forward and his eyes shifted downward and to the right side of the screen. This would correlate with index Eyes (+1,−1), when following the convention disclosed herein.

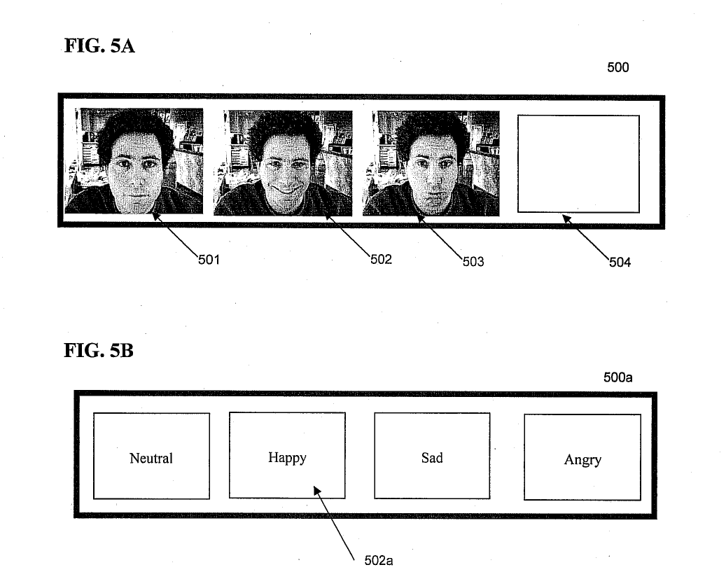

Referring to FIG. 5A, a plurality of images stored in the database, each depicting a facial expression of the user. For example, image 501 shows the user with a neutral facial expression. Image 502 shows the user with a happy facial expression. Image 503 shows the user with a sad facial expression. Image 504 shows the user with an angry facial expression. Each of these images are indexed based upon the expression they correspond to as indicated by FIG. 5B. Thus, the images are indexed with respect to “neutral,” “happy,” “sad,” and “angry,” respectively. Additional facial expressions such as surprise, confusion, concern, boredom, and/or excitement could also be stored and indexed in a similar manner.

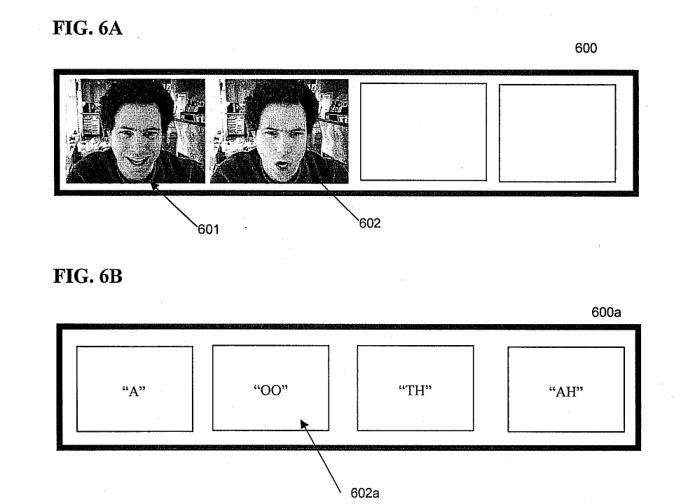

Referring to FIG. 6A, a plurality of images stored in the database, each depicting a facial pose of the user correlating with the production of a particular verbal phonic sound. For example, image 601 shows the user producing an “A” vowel sound. Image 602 shows the user producing an “OO” vowel sound. Each of these images is indexed based upon the expression they correspond to as indicated by FIG. 6B. Additional phonic production facial poses may be stored for other sounds such as mmmm, “th,” “p”, “ch”, etc. . . .

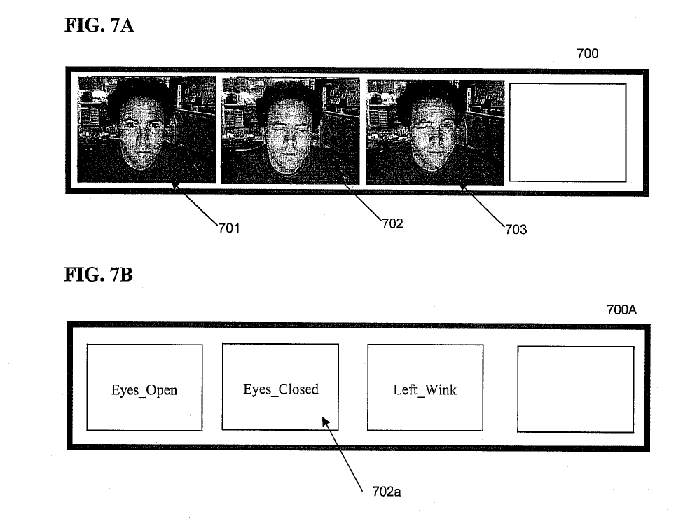

Referring to FIG. 7A, a plurality of images stored in the database, each depicting a facial pose of the user correlating with a different open and close eye condition of the user. For example, image 701 shows the user with both eyes open. Image 702 shows the user with both eyes closed. Image 703 shows the user with one eye closed. Each of these images are indexed based upon the eye condition they correspond to as indicated by FIG. 7B. In addition, although not illustrated in the figures, a plurality of images may be stored in the database depicting facial poses of each of a plurality of different mouth open and close conditions, from fully shut to partially open to wide open. Such facial poses may be used to simulate, for example, yawning and/or yelling and/or singing of the animated self-portrait.

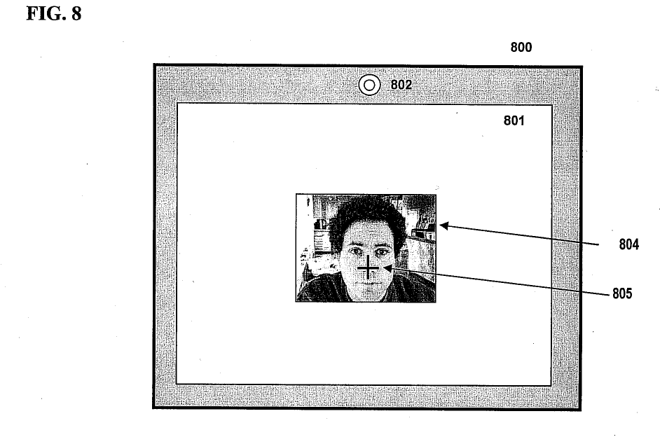

The teaching herein describe an automated image capture process. An important feature of the present invention is the automated method by which a set of systematic facial images may be collected and stored in a database by the routines of the present invention, capturing a plurality of specific facial poses of the user and correlating them with appropriate relational indexes. To make this process simple enough that even a young child can do it, the routines of embodiments of the present invention are configured to prompt the user to perform each of a plurality of different facial poses required of the database and captures an image for each, storing the image in the database and associating the image with the correct relational index. This is achieved, for example, by (a) having the user face each of a plurality of specific different facial directions in response to a specific computer prompt for each and taking a corresponding digital photograph for each facial direction, (b) having the user shift their eyes in each of a plurality of specific different eye gaze directions in response to a specific computer prompt for each and taking a corresponding digital photograph for each gaze direction, (c) having the user execute a plurality of specific different open and close eye conditions in response to a specific computer prompt for each and taking a corresponding digital photograph for each eye condition, (d) having the user execute a plurality of specific different open and close mouth conditions in response to a specific computer prompt for each and taking a corresponding digital photograph for each mouth condition, (e) having the user execute a plurality of specific different phonic sound production conditions in response to a specific computer prompt for each and taking a corresponding digital photograph for each phonic sound production condition, and (f) having the user execute a plurality of specific different facial expressions in response to a specific computer prompt for each and taking a corresponding digital photograph for each facial expression. Examples of how such automated prompting, photographing, and indexing may be performed are described with respect to FIGS. 8, 9 and 10 below.

FIG. 8 illustrates a monitor 800 having an embedded digital camera 802 and a display screen area 801 according to an embodiment of the invention. A software routine runs upon computer 1 (not shown), displaying images on screen 801, capturing images from camera 802 and outputting sounds from speakers (not shown). The software routines include Automated Image Capture routines that are operative to (a) prompt the user to execute a specific facial pose, (b) assist the user in achieving that facial pose in a spatially registered manner, (c) enable the user to provide input indicating that the prompted pose has been achieved, (d) in response to the user input, capturing an image of the user, (f) storing the image in memory, and (g) indexing the stored image such that it is relationally associated with the specific prompted pose that the user was instructed to perform. This process may be performed for each of a variety of different facial pose types, including Facial Direction Poses, Eye Direction Poses, Facial Expression Poses, Phonic Sound Poses, Open and Closed Eye Condition Poses, Open and Close Mouth Condition Poses.

With respect to Automated Image Capture for Eye Direction Poses, the method may be performed as follows. A graphical cross hairs 805 or other graphical element is displayed upon the screen. The user's live real time video image 804, as captured by camera 802 is also displayed upon the screen 801. In general, the cross hairs are displayed at a central location upon the screen 801, directly below the camera 802. The user's live real-time video image 804 is also displayed at a central location upon the screen. The software routines of embodiments of the present invention then begin the automated image capture for eye direction poses. The process begins with a prompt being issued to the user by the computer software, either as a textual or aural content. The prompt instructs the user to face directly forward, gaze directly forward at the screen, and align a part of his or her face with the cross hairs. In a common embodiment the user is instructed to align the tip of his or her nose with the cross hairs. Upon doing this, the image will appear as shown at 804 in FIG. 8. The software then prompts the user to provide an input indicating his or her image at 804 is properly aligned (i.e., is directly forward and the cross hairs line up with his or her nose as displayed at 804). The user input may be for example a button press, a verbal command, a touch screen input, or a mouse click. Upon receiving the user input, the software captures a still image of the user as depicted at 804. The image is stored in memory and indexed with respect to the prompted facial pose, which in this case was facing directly forward and gazing directly forward. The index thus may be for example, Eyes (0,0), as was described with respect to FIG. 4B and stored as element 401 in FIG. 4A.

The software then proceeds to instruct the user, through a series of similar facial pose prompts, to look in a gaze in a variety of different directions by moving only his eyes, while keeping face aimed directly forward, and his nose aligned with cross hairs 805. To prompt the user to gaze in directions that correspond with the desired facial poses, the software displays a series of eye-gaze markers, upon the display of each marker instructing the user to gaze at it.

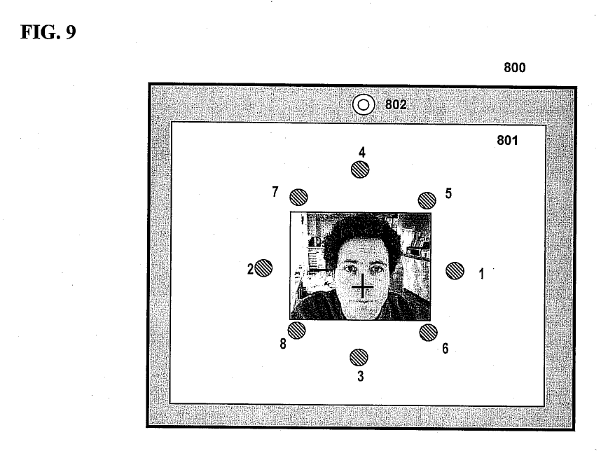

FIG. 9 illustrates eye gaze markers according to an embodiment of the invention. As shown, the software may be configured to first display the circular marker #1. Upon displaying the marker, the software instructs the user (through text and/or aural verbal output), to look directly forward, keep his nose aligned with the cross hairs, and aim his eyes towards circular marker #1. Upon achieving this, the user is instructed to enter the user input (i.e., press a button, utter a command, or otherwise provide computer input) informing the computer that he is aligned. Ideally, the command does not require the user to look to perform it, for example pressing the space bar or uttering “ready”. Upon receiving the user input, the software captures a still image of the user as he performs the prompted facial pose. The image is stored and indexed, for example being stored as image 410 in FIG. 4A with index Eyes (+1, 0) as shown in FIG. 4B. This process then repeats again and again, each time displaying a different gaze target (i.e. target 2, 3, 4, 5, 6, 7, and 8) as shown in FIG. 9. During each iteration, the user is prompted to face directly forward, align his nose with the target, and then gaze at the displayed eye target. Upon receiving a user input indicating that the prompted facial pose is achieved, the software captures a still image, stores it in memory, and indexes the image, for example as shown in corresponding locations of FIG. 4B.

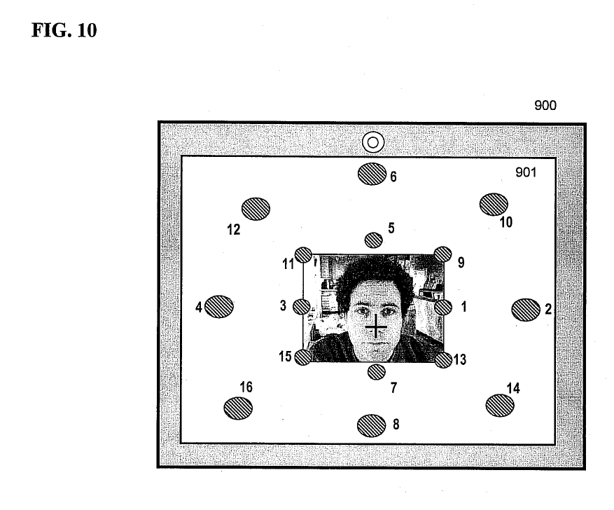

With respect to Automated Image Capture for Facial Direction Poses, a similar method may be performed as follows. Again, a graphical cross hairs 805 or other graphical element is displayed upon the screen. The user's live real time video image 804, as captured by camera 802 is also displayed upon the screen 801. In general the cross hairs are displayed at a central location upon the screen 801, directly below the camera 802. The user's live real-time video image 804 is also displayed at a central location upon the screen. The software of the present invention then begins the automated image capture for facial direction poses. The process beings with a prompt being issued to the user by the computer software, either as a textual or aural content. The prompt instructs the user to face directly forward, gaze directly forward at the screen, and align a part of his or her face with the cross hairs. In a common embodiment, the user is instructed to align the tip of his or her nose with the cross hairs. Upon doing this, the image will appear as shown in FIG. 10.

FIG. 10 illustrates automated head direction targets according to an embodiment of the invention. The software then prompts the user to provide an input indicating his image is properly aligned (i.e., is directly forward and the cross hairs line up with his or her nose as displayed). Upon receiving the user input, the software captures a still image of the user as depicted. The image is stored in memory and indexed with respect to the prompted facial pose, which in this case was facing directly forward and looking straight ahead. The index may be, for example, FACE (0, 0) as was described with respect to FIG. 3B as element 301a and stored as element 301 in FIG. 3A.

The software then proceeds to instruct the user, through a series of differing facial pose prompts, each time instructing the user to move his or her neck so as to aim his or her nose in different facial directions. To prompt the user to point his or her nose in directions that correspond with the desired facial direction poses, the software displays a series of facial direction markers. These markers are shown with respect to FIG. 10. For example, as shown in FIG. 10, the software may be configured to first display the circular marker #1. Upon displaying the marker, the software instructs the user (through text and/or aural verbal output), to turn his head until his nose is aimed approximately at circular marker #1. Upon achieving this, the user is instructed to enter the user input (i.e., press a button, utter a command, or otherwise provide computer input) informing the computer that he is aligned. Ideally the command does not require the user to look to perform it, for example pressing the space bar or uttering “ready.” Upon receiving the user input, the software captures a still image of the user as he performs the prompted facial pose. The image is stored and indexed, for example being stored as image 310 in FIG. 3A with index Face (+1, 0) as shown in FIG. 3B. This process then repeats again and again, each time displaying a different facial direction target (i.e., targets 2 through 16) as shown in FIG. 10. At each iteration, the user is prompted to first align his nose with the cross hairs, then adjust his neck so as to aim his nose with the then displayed target, gazing generally forward as he does this. Upon receiving a user input indicating that the prompted facial pose is achieved, the software captures a still image, stores it in memory, and indexes the image, for example as shown in corresponding locations of FIG. 3B. In this way a full set of images, as shown in FIG. 3A, may be collected and indexed appropriately (i.e., with indexes as shown in FIG. 3B).

A similar method is performed with respect to Automated Image Capture for Phonic Sound Poses, as discussed below. Again, a graphical cross hairs 805 or other graphical element is displayed upon the screen. The user's live real time video image 804, as captured by camera 802 is also displayed upon the screen 801. In general the cross hairs 805 are displayed at a central location upon the screen 801, directly below the camera 802. The user's live real-time video image 804 is also displayed at a central location upon the screen. The software according to an embodiment of the present invention then begins the automated image capture for phonic sound poses. The process beings with a prompt being issued to the user by the computer software, either as a textual or aural content. The prompt instructs the user to face directly forward, gaze directly forward at the screen, and align a part of his or her face with the cross hairs. In a common embodiment the user is instructed to align the tip of his or her nose with the cross hairs. Upon doing so, the image will appear as shown in FIG. 8. The software then prompts the user to make a facial pose that corresponds with uttering a particular sound. For example, the software may ask the user to make an image corresponding with “ah” sound. In some embodiments a graphical cartoon is shown on the side of the screen, indicating what the facial pose should look like. The software then prompts the user to provide an input indicating his image is properly aligned (i.e. is directly forward and the cross hairs line up with his or her nose as displayed) and when the phonic sound pose is performed. Upon receiving the user input, the software captures a still image of the user as depicted. The image is stored in memory and indexed with respect to the prompted facial pose, which in this case was for an “Ah” sound. The process then repeats for a plurality of different phonic sound facial poses, each indexed with respect to its corresponding sound pose.

A similar method is performed with respect to Automated Image Capture for Facial Expression Poses, as discussed below. Again, a graphical cross hairs 805 or other graphical element is displayed upon the screen. The user's live real time video image 804, as captured by camera 802 is also displayed upon the screen 801. In general the cross hairs are displayed at a central location upon the screen 801, directly below the camera 802. The user's live real-time video image 804 is also displayed at a central location upon the screen. The software of the present invention then begins the automated image capture for facial expression poses. The process begins with a prompt being issued to the user by the computer software, either as a textual or aural content. The prompt instructs the user to face directly forward, gaze directly forward at the screen, and align a part of his or her face with the cross hairs. In a common embodiment the user is instructed to align the tip of his or her nose with the cross hairs. Upon doing so, the image will appear as shown in FIG. 8. The software then prompts the user to make a facial pose that corresponds with a particular facial expression. For example, the software may ask the user to make an image corresponding with “angry” facial expression. In some embodiments a graphical cartoon is shown on the side of the screen, indicating what the facial pose should look like for that emotion. The software then prompts the user to provide an input indicating his image is properly aligned (i.e., is directly forward and the cross hairs line up with his or her nose as displayed) and when the facial expression pose is performed. Upon receiving the user input, the software captures a still image of the user as depicted. The image is stored in memory and indexed with respect to the facial expression pose, which in this case was for an “angry” expression. The process then repeats for a plurality of different facial expression poses, each indexed with respect to its corresponding facial expression pose. The facial expressions may include, for example happy, sad, bored, confused, concerned, surprised, excited, scared, and angry facial poses.

A similar method is performed with respect to Automated Image Capture for Eye Condition Poses, as discussed below. Again, a graphical cross hairs 805 or other graphical element is displayed upon the screen. The user's live real time video image 804, as captured by camera 802 is also displayed upon the screen 801. In general the cross hairs are displayed at a central location upon the screen 801, directly below the camera 802. The user's live real-time video image 804 is also displayed at a central location upon the screen. The software of the present invention then begins the automated image capture for eye condition poses. The process begins with a prompt being issued to the user by the computer software, either as a textual or aural content. The prompt instructs the user to face directly forward, gaze directly forward at the screen, and align a part of his or her face with the cross hairs. In a common embodiment the user is instructed to align the tip of his or her nose with the cross hairs. Upon doing so, the image will appear as shown in FIG. 8. The software then prompts the user to make an eye pose that corresponds with a particular eye condition. For example, the software may ask the user to close his eyes. The software then prompts the user to provide an input indicating his image is properly aligned (i.e., is directly forward and the cross hairs line up with his or her nose as displayed) and when the eye condition pose is performed. Upon receiving the user input, the software captures a still image of the user. The image is stored in memory and indexed with respect to the eye pose, which in this case was for both eyes closed. The process may then repeat for a plurality of different poses, each indexed with respect to its corresponding eye condition. A similar process may be followed for a plurality of open-and-close mouth conditions.

It should be appreciated that in some embodiments of the present invention the user may be asked to turn his back to the computer such that a photograph of the back of his or her head may be captured and indexed within the database.

The teachings discussed herein provided Portrait Animation Processes. Such processes involve creating and displaying an animated version of the user, referred to herein as an animated self-portrait. The processes are comprised of two primary processes—a first process of systematically capturing and indexing an image database by photographing a user who is prompted to perform a set of facial poses using displayed graphical references (as described above), and a second process of using the image database to create a lifelike moving rendition of the user that can be manipulated in a variety of manners under computer control.

The second process is generally performed by animated self-portrait software routines that accesses images in the image database and displays them, one at a time, in rapid temporal sequence, in a co-located manner. The sequences are carefully controlled so as to create a stop motion animation illusion that the user is an animated character that is performing lifelike behaviors. By displaying the images in different specific sequences, a variety of different lifelike behaviors can be displayed. The sequences are generally displayed quickly, for example at a rate of 6 frames per second or higher, when the animated self-portrait is performing a moving behavior (for example, in a look-around routine as described below). When the animated self-portrait is not moving the displayed frame may be held unchanging, or may be varied at a slower rate (for example, in a blinking routine as described below).

Thus, the animated self-portrait is displayed much a movie (i.e., by rapidly cycling through sequential image frames), but unlike a movie wherein the frames play in a fixed pre-scripted order, the order of the frames as displayed in an animated self-portrait are varied in real-time to create a variety of different behaviors with only relatively small number of stored images. Thus, an important feature of the animated self-portrait software routines is the ability to select appropriate images from memory, sequencing them in a meaningful way that creates a lifelike behavior, and vary the sequencing over time to create a variety of different lifelike behaviors using the same data store of image frames. Ideally, the lifelike behaviors are varied in real time to appear responsive to events within the computer environment such as the output of music, the changing of software or operating system status, user interaction with an interface such as the moving a cursor, the arrival of an instant message, the ringing of a phone, the detection of a voice by a microphone, typing on the keyboard, and so forth. In such ways, the animated self-portrait may seem alive by acting responsive to changing events, for example having the animated self portrait moved under computer control such that it (a) appears startled at the arrival of an instant message or phone call or email, (b) appears bored after a long period of user inactivity upon the user interface of the computer, (c) follows the cursor with roving eyes, (d) shakes its head back and forth to indicate a user action is not allowed, (e) nods its head up and down to indicate that a user action is allowed, (f) sings along with playing music, (g) closes its eyes right before a screen saver dims the screen, (h) looks in the direction of a detected facial image by a camera of the computer system, (i) moves its mouth along with computer generated vocalizations, (k) blinks intermittently with the passage of time, (l) looks in the direction of a new window or message that appears on the screen, (m) looks towards a prompt that requires user attention, (n) winks in response to a received user input, (o) nods affirmatively in response to a user input or query, (p) tells a digitized joke or story, (q) laughs in response to a user error or the display of an error message, (r) swirls gaze around quickly in response to a confusing user input, (s) appears excited in response to a user being awarded points or credits, and/or (t) appears disappointed in response to a user losing points or credits.

In some embodiments a user may create a web page and include one or more animated self portraits of himself within the web page content. The animated self portrait may be configured to produce particular simulated facial behaviors in response to particular interactions with the web page by third party users. For example, a third party user visiting the web page of a particular user, may view an animated self portrait of the particular user upon the web page. The animated self portrait may produce a variety of simulated facial behaviors, as described above, in response to the third party user's interaction with the web page. For example, the animated self portrait may appear board after a long period of inactivity by the third party user upon the web page. Similarly, the animated self portrait may change its gaze direction and/or its facial direction so as to appear to follow the motion of the cursor as the third party user interacts with the web page. Similarly, the animated self portrait may be made to nod, shake its head, wink, sing, talk, laugh, appear excited, appear disappointed, or yawn in response to particular the third party interactions with the web page.

Creating such behaviors in response to detected events within a computer environment requires the accessing and display of particular sequences of images from the image database at the appropriate time. Thus the routines of the present invention may be configured to execute each of a plurality of unique behavioral sequences in response to particular detected events, each unique sequence corresponding to a series of particular indexes within the image database. In this way a single set of facial pose images may be used to create of a plurality of different simulated behaviors based upon the unique sequence in which they are displayed. Example sequences of images from the image database that achieve particular simulated behaviors are discussed below.

One exemplary sequence is of a Simulated Forward Facing Behavior. As its name implies, this is a simulated behavior of the animated self-portrait wherein it appears to be looking directly forward out of the screen. In an example embodiment of the simulated forward facing behavior, the process starts with a frontal facing image being accessed and displayed, for example image 301 of FIG. 3A. This image is accessed using its relational index Face (0, 0). This image may be displayed over an extended period, for example ten to twenty seconds, without any other image being displayed. In this preferred embodiment, however, an occasional blink image (for example, image 701 of FIG. 7A, as indexed by Eyes_Closed) is momentarily displayed between Face(0,0) image displays. In one such embodiment Face (0,0) is displayed for 4700 milliseconds, followed Eyes_Closed for 300 milliseconds. This repeats in 5000 millisecond cycles while the facial image is displaying a forward-looking behavior. Thus the image does not appear static, as it would if it were just a photograph, but appears to blink once every five seconds during the frontal facing period. The end result is an animated self-portrait exhibiting a frontal facing behavior with intermittent blinks. The Simulated Forward Facing Behavior may be displayed for extended periods, but generally is controlled to be displayed for 10 to 20 seconds, followed by a Simulated Look Around Behavior, Simulated Yawn Behavior, Simulated Smile Behavior, Simulated Laughing Behavior, or some other alternate behavior as described below.

Another exemplary sequence is of a Simulated Look Around Behavior. As the name implies, this is a simulated behavior of the animated self-portrait wherein it appears to be looking all around by facing different directions. In a Clockwise Look-Around embodiment, the look around behavior causes the animated self-portrait to gaze smoothly around in an apparent clockwise circle, for example leftward, then downward, then rightward, then upward. The process generally starts with a frontal facing image being accessed and displayed, for example image 301 of FIG. 3A. This image is accessed using its relational index Face (0,0). This image may be displayed over an extended period, for example three seconds, without any other image being displayed. This is then followed by a rapid sequence of images that are accessed from the database and displayed so as to simulate the clockwise look-around behavior. The sequence of images must correspond with a leftward face direction image, a downward face direction image, a rightward face direction image, and an upward face direction image. Such images exist in the database, as shown in FIG. 3A, and may be referenced by their unique and known index values as shown in FIG. 3B, for example Face (−1, 0) followed by Face (0, −1) followed by Face (+1, 0) followed by Face (0, +2). Each image is displayed for a short period of time, for example between 100 and 400 milliseconds each. To create a smoothly circular clockwise look around, each image is displayed for approximately the same amount of time, the shorter that time the faster the look around. Thus, by modulating the time duration the speed of the look around may be varied. Also, by reversing the order of the sequence, a Counter Clockwise Look-Around may be selectively displayed. By accessing the database and displaying the four images [Face (−1, 0)/Face (0, −1)/Face (+1, 0)/Face (0, +2)] in rapid succession, a variety of look around behaviors can be created including a clockwise look around and a counter clockwise look around, each at a variable speed of looking. In addition, the simulated look around behavior can be smoothly combined with other behaviors as described herein. Moreover, the full circle of the look around need not be imparted under computer control, for example only a portion of the clockwise or counterclockwise sequence may be imparted. In addition, the look around cycle need not start with the leftward image as described above, but may start with any of the four directional facing images so long as they cycle smoothly in the logical order of looking. For example a user may be made to look back and forth overhead in a smooth ark, as if watching a ball being thrown back and forth over him. This may be achieved by cycling Face (−1, 0) to Face (0, +2) to Face (+1, 0) to Face (0, +2) and then cycling back to the beginning of the sequence.

Another exemplary sequence is of Simulated Roving Eyes Behavior. As the name implies, this is a simulated behavior of the animated self-portrait wherein it the eyes appear to be moving around. A variety of different eye motions may be achieved based upon the image selection and display from the database, including shifting eyes left and right, shifting eyes up and down, circling eyes clockwise, circling eyes counter clockwise, and so forth. As an example, a circling eyes clockwise behavior, the animated self-portrait appears to gaze smoothly around in an apparent clockwise circle, for example leftward, then downward, then rightward, then upward. The process generally starts with a frontal facing image being accessed and displayed, for example image 301 of FIG. 3A. This image is accessed using its relational index Face (0, 0). This image may be displayed over an extended period, for example three seconds, without any other image being displayed. This is then followed by a rapid sequence of images that are accessed from the database and displayed in rapid succession so as to simulate the clockwise gaze behavior. The sequence of images must correspond with a leftward eyes gaze image, a downward eye gaze image, a rightward eye gaze image, and an upward eye gaze image. Such images exist in the database, as shown in FIG. 4A, and may be referenced by their unique and known index values as shown in FIG. 4B, for example Eyes (−1, 0) followed by Eyes (0, −1) followed by Eyes (+1, 0) followed by Eyes (0, +1). Each image is displayed for a short period of time, for example between 100 and 400 milliseconds each. To create a smoothly circular clockwise gaze, each image is displayed for approximately the same amount of time, the shorter that time the faster the circular gaze motion is imparted. Thus, by modulating the time duration the speed of the simulated gaze moving may be varied. Also, by reversing the order of the sequence, a counter clockwise gaze may be selectively displayed. In addition, the full circle need not be imparted under computer control, for example only a portion of the clockwise or counterclockwise sequence may be imparted. Moreover, the roving gaze need not start with the leftward gaze image as described above, but may start with any of the four directional facing images so long as they cycle in a logical order. For example, a user may be made to look back and forth, as if watching a ping-pong-game, be achieved by cycling Eyes (−1, 0) to Face (0, 0) to Eyes (+1, 0) to Face (0, 0) and then cycling back to the beginning of the sequence.

An additional exemplary sequence is of Simulated Nodding. As the name implies, this is a simulated behavior of the animated self-portrait wherein it the head appears to nod, for example in affirmation. The process generally starts with a frontal facing image being accessed and displayed, for example image 301 of FIG. 3A. This image is accessed using its relational index Face (0, 0). This image may be displayed over an extended period, for example three seconds, without any other image being displayed. This is then followed by a rapid sequence of images that are accessed from the database and displayed so as to simulate the nodding behavior. The sequence of images must correspond with a sequence of upward, forward, downward, and then forward facial directions, the sequence repeating numerous times. Such images exist in the database, as shown in FIG. 3A, and may be referenced by their unique and known index values as shown in FIG. 3B. For example, a nodding behavior may be generated by accessing and displaying in sequence the images indexed as: Face (0, +1) then Face (0, 0) then Face (0, −1) then Face (0, 0) then repeating the cycle a number of times. The more times it is repeated, there will be more nodding. The longer the display of each image, the slower the nodding. Each image is displayed for a short period of time, for example between 100 and 400 milliseconds each.

In some embodiments a single simulated head nod may be displayed with the final image depicting a downward head direction remaining over a substantial period of time so as to simulate the behavior of the animated self portrait dozing off. This may be displayed in response to inactivity within the computer environment, for example no user input for more than a threshold amount of time. Thus, in response to no user input for more than a threshold amount of time, the animated self-portrait may be displayed with eyes closed and/or with head down, emulating a dozing facial pose posture. Upon user input, the image may be restored to Face (0, 0) or some other alert facial pose, indicating a return to alertness of the animated self-portrait.

Another exemplary sequence is of a Simulated Head Shake. As the name implies, this is a simulated behavior of the animated self-portrait wherein it the head appears to shake back and forth, for example a negative gesture. The process generally starts with a frontal facing image being accessed and displayed, for example image 301 of FIG. 3A. This image is accessed using its relational index Face (0, 0). This image may be displayed over an extended period, for example three seconds, without any other image being displayed. This is then followed by a rapid sequence of images that are accessed from the database and displayed so as to simulate the headshake behavior. The sequence of images must correspond with a sequence of leftward, forward, rightward, and then forward facial directions, the sequence repeating numerous times. Such images exist in the database, as shown in FIG. 3A, and may be referenced by their unique and known index values as shown in FIG. 3B. For example, a head shake behavior may be generated by accessing and displaying in sequence the images indexed as: Face (−1, 0) then Face (0, 0) then Face (+1, 0) then Face (0, 0), then repeating the cycle a number of times. The more times it is repeated, there will be more shaking. The longer the display of each image, the slower the head shaking. Each image is displayed for a short period of time, especially in head shaking because it is generally a fast gesture, for example between 100 and 300 milliseconds each.

An additional exemplary sequence is of Simulated Mouth Motion Behaviors. A variety of simulated mouth motion behaviors may be achieved by accessing and displaying images from the database that are indexed to correspond with various mouth condition poses of the user. For example, by accessing images of various phonic sound facial poses, as shown in FIG. 6A, the animated self-portrait may be made to appear to speak. By displaying a wide-open mouth facial pose, the animated self-portrait may be made to appear to yawn or sing. Because yawning and singing may appear similar, outputting appropriate sounds synchronously with the facial pose strengthens the illusion. For talking or singing, correlating the changes in facial mouth pose with syllables and/or other verbal changes strengthens the illusion. In some preferred embodiments of the invention, facial poses are accessed and displayed from the self portrait image database in response to a playing audio file, the playing audio file including spoken verbalizations and/or singing verbalizations. Using signal processing techniques known to the art, the audio content that includes spoken or singing verbalizations may be processed to determine changes in verbal content. Embodiments of the present invention may be configured to display mouth motion images such that changes in mouth pose are made to correspond with changes in audio verbal content. In this way the animated self-portrait of the user may be made to appear to talk or sing in concert with the audio verbalizations.

Another exemplary sequence is of Simulated Emotion Behaviors. A variety of simulated emotions may be imparted upon the animated self-portrait by accessing images from the database that are indexed to correspond with certain emotional facial poses of the user. For example, by accessing images of various facial expression poses, as shown in FIG. 5A, the animated self-portrait may be made to appear to vary its emotional state. The changes in apparent emotional state are modulated under software control, ideally to correspond with other events that are detected by the software. For example, the arrival of an instant message, text message, email, phone call, or other incoming element of communication may be detected by the software routines of the present invention, which may in response display a facial pose of the user corresponding with surprise and/or excitement. In some embodiments facial expressions and/or animated behaviors may be relationally associated with the third party user who is the source of the communication. For example, an image of excitement and/or an animated behavior of excitement by the animated self portrait may be relationally associated with the arrival of a communication from a third party user of whom the user is particularly fond. Similarly, an image of disappointment or an animated behavior of disappointment by the animated self-portrait may be relationally associated with the arrival of a communication from a third party of which the user is not particularly fond.

It should be appreciated that an animated behavior of excitement may be generated by combining a facial pose of happiness or excitement in sequence with an upward facial direction or upward eye direction. For example, an animated behavior of excitement may be generated by combining image 502 of a happy facial pose as shown with respect to FIG. 5A, in a sequential combination with image 345 of an upward facial direction as shown with respect to FIG. 3A. Similarly, an animated behavior of disappointment may be generated by combining a facial pose of anger or sadness or disappointment in sequence with a downward facial direction or upward eye direction. For example, an animated behavior of disappointment may be generated by combining image 503 of a sad facial pose as shown with respect to FIG. 5A, in a sequential combination with image 330 of a downward facial direction as shown with respect to FIG. 3A. In such way an animated emotional behavior may be created that is a combination of images from the self-portrait database, played in rapid sequence under computer control, that portrays a particular emotional characteristic in the animated self-portrait. In preferred embodiments the animated emotional behavior includes both facial expressions and head motions, for such combinations are more evocative than facial expressions alone.

An additional exemplary sequence is of a Real-Time Gaze or Facial Direction. In some embodiments of the present invention the sequence of images accessed from the self-portrait image database and displayed to the user, are accessed and displayed in approximately real-time correlation with a detected moving cursor, detected moving simulated object, and/or detected image from a camera. For example, in some such embodiment the animated self-portrait is modulated under software control such that the eye gaze appears to approximately follow the current cursor location upon the screen. This is achieved by computing a directional vector between a current display location of an animated self-portrait (for example the current display of the center of the image) and a current display location of the cursor. Based upon the orientation of that directional vector, gaze direction image is selected form the image database that most closely matches the directional vector. This image is displayed until changes in the cursor location (or the animated self portrait display location) cause the computed directional vector to change enough that a new gaze direction image more closely matches the directional vector. By continually doing such a process over an extended time, the animated self portrait is appears like it is following the cursor with its eyes and thus seems like it is executing a responsive lifelike behavior.

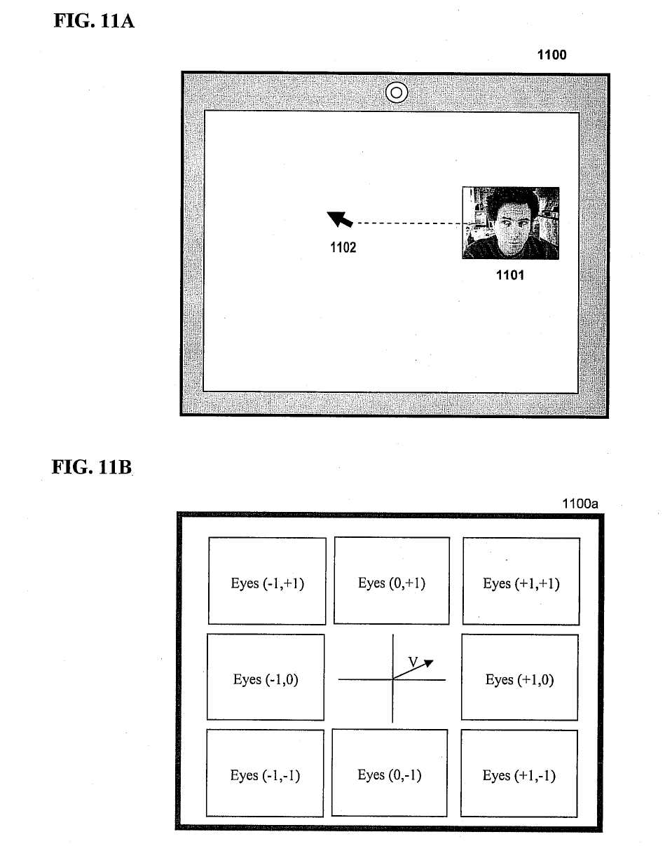

FIG. 11A illustrates an example of how the display screen may appear at a particular instant during real-time gaze following according to an embodiment of the invention. As shown, the animated self-portrait 1101 is displayed upon the screen at a first location. A moving graphical object, in this case the cursor 1102, is displayed upon the screen at a second location. An orientational vector V is computed that points from the first location to the second location. Based upon the value of orientational vector V, an image is selected from the image database such that the eye direction of the image corresponds most closely with the orientation represented by vector V. In this case, it is image Eyes (−1, 0), which corresponds with a substantially leftward looking eye gaze. This is displayed, making it appear as if the animated self-portrait is looking at the cursor. As the cursor changes position, the displayed image is updated repeatedly. For example, if the cursor dropped substantially lower upon the screen, image Eyes (−1, −1) would be displayed. If the cursor rose substantially higher upon the screen, image Eyes (−1, +1) would be displayed. If the cursor was moved to the center of image 1101, for example upon the user's nose, then Eyes (0, 0) would be displayed. If the cursor was just to the right of image 1101, then Eyes (+1, 0) would be displayed. By changing the displayed facial pose image in real time in this way, the self-portrait of the user appears to come alive and watch the cursor.

FIG. 11B illustrates an example of the mathematical mapping between vector angles and eye pose indexes according to an embodiment of the invention. This mapping uses a traditional polar coordinate system for the directional vector V, wherein 0 degrees is directly vertical and wherein the angular coordinate increases clockwise around the origin, a relational mapping is defined that correlates ranges of vector angles with specific eye gaze pose image indexes. Using such a mapping, the image with index Eyes (0, +1) is displayed when the vector V is closest to 0 degree, the image with index Eyes (+1, +1) is displayed when the vector V is closest to 45 degrees, the image with index (+1, 0) is displayed when the vector V is closest to 90 degrees, the image with index (+1, −1) is displayed when the vector V is closest to 135 degrees, the image with index Eyes (0, −1) is displayed when the vector V is closest to 180 degrees, the image with index Eyes (−1, −1) is displayed when the vector V is closest to 225 degrees, the image with index Eyes (−1, 0) is displayed when the vector V is closest to 270 degrees, and the image with index Eyes (−1, +1) is displayed when the vector is closest to 315 degrees. It should be noted that in some embodiments this mapping is only used when the cursor distance from the center of the animated self-portrait is greater than a threshold distance (for example greater than half the size of the portrait image). In other words, it is used when the cursor is not upon the self portrait image itself, but when the cursor (or other object being gaze-tracked) is on the self portrait image itself, a different mapping may be used. In some embodiments, when the cursor is on the self-portrait image, a frontal looking image is used, for example Face (0, 0). In this way the animated self-portrait is made to look directly forward when the cursor is front of the animated self-portrait image, but is made to gaze in varying directions when the cursor (other gaze tracked object) is outside the boundaries of the animated self-portrait image. It should also be noted that because the vector V depicts the orientation of a vector between a target object for gaze tracking (i.e., the cursor) and the location of the animated self portrait itself, the target object could be stationary and the animated self portrait location could be in motion, during the gaze tracking event. Alternatively, both could be in motion. In this way, the animated self-portrait can be made to look at any target object (such as the cursor or other graphical object on the screen) and gaze in the relative direction towards that target object in substantially real-time, thus making the animated portrait seem lifelike. The animated self-portrait may also look at objects that suddenly appear on the screen, such as a window, message, image, or icon, using the same vector method described above.

It should be appreciated that instead of varying eye gaze location to follow a moving cursor, other moving graphical object, or a moving detected object in the camera image, the animated self-portrait may be made to vary facial direction. This follows the same process as described above for eye gaze, but instead uses Face (x, y) images as stored in the database described with respect to FIG. 3A. In this way the animated self portrait may be made to face in a direction that corresponds with the currently changing relative position of a cursor, other moving object, other displayed object, or object detected within a camera image.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks. No specific limitation is intended to a particular system or device. Other variations and embodiments are possible in light of above teachings, and it is not intended that this Detailed Description limit the scope of invention

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A system for generating an animated self-portrait of a user, the system comprising:
a camera to capture a plurality of self-portrait photos of a user, each of the plurality of self-portrait photos depicting the user in one a plurality of different facial poses, the plurality of different facial poses including a plurality of different facial angles, eye-gaze directions, and facial expressions of the user;
an image database for storing the plurality of self-portrait photos of the user, wherein each of the self-portrait photos is indexed with respect to at least one of a designated facial angle, a designated eye gaze direction, and a designated facial expression depicted in the self-portrait photo;
a processor to implement software routines to
detect an event within a computer environment;
select a simulated facial behavior in response to the detected event;
determine an image sequence in to be displayed in accordance with the selected simulated facial behavior;
access a particular plurality of self-portrait photos from the image database in accordance with the determined image sequence, the accessing being performed based at least in part on index information associated with each of the particular plurality of self-portrait photos, the index information indicating at least one of the designated facial angle, the designated eye gaze direction, and the designated facial expression; and
display the particular plurality of self-portrait photos in rapid succession and in accordance with the determined image sequence so as to produce an animated depiction of the user's face performing the selected simulated facial behavior.

2. The system of claim 1 wherein the selected simulated facial behavior is one of a simulated look around behavior, simulated yawn behavior, simulated roving eyes behavior, simulated nodding behavior, simulated head shake behavior, simulated talking behavior, simulated singing behavior, and simulated laughing behavior.

3. The system of claim 1 wherein at least one the self-portrait photographs is indexed with respect to at least one of an opened or closed eye condition, an open or closed mouth condition, and a phonic sound production condition depicted in the self-portrait photo.

4. The system of claim 1 wherein a speed of the displayed simulated facial behavior is modulated by the processor by varying the duration for which one or more of the particular plurality of self-portrait photos are displayed.

5. The system of claim 1 wherein the simulated facial behavior is reversed by reversing the sequence by which the particular plurality of self-portrait photos are displayed.

6. The system of claim 1 wherein the selected simulated facial behavior is at least one of a real-time gaze following and a real-time facial direction following behavior in which the animated depiction of the user appears to vary the direction it is looking so as to follow the changing position of at least one displayed object upon the screen.

7. The system of claim 1 wherein the selected simulated facial behavior is at least one of a real-time gaze following and a real-time facial direction following behavior in which the animated depiction of the user appears to vary the direction it is looking so as to follow the changing position of at least one object detected by the camera.

8. The system of claim 1 wherein the detected event is a detected receipt of at least one of an Instant Message, a telephone call, an email, and a received user input.

9. The system of claim 1 wherein the detected event is an interaction with a web page.

10. The system of claim 1 wherein the detected event is at least one of an award of points or credits, a debit of points or credits, an output of music, an output of computer generated vocalizations, the display of a user prompt, the display of an error message, and a display of a graphical window.

11. An automated method for capturing and indexing facial images in a facial image database, the method comprising
prompting a user to execute a specific facial pose;
assisting the user in achieving the prompted pose in a spatially registered manner;
enabling the user to provide a user input indicating that the prompted pose has been achieved;
capturing the facial image of the use in response to the user input;
storing the facial image in the facial image database; and
indexing the stored facial image such that the stored facial image is relationally associated with a specific prompted pose that the user was instructed to perform.

12. The automated method of claim 11 further comprising repeatedly performing steps of prompting, assisting, enabling, capturing, storing, and indexing, for each of a plurality of different specific facial poses;

13. The automated method of claim 12 wherein the plurality of different facial poses include a plurality of different facial angles, eye-gaze directions, and facial expressions of the user.

14. The automated method of claim 12 wherein the plurality of different facial poses include a plurality of phonic sound production conditions.

15. The method of claim 12 wherein the indexing comprises categorizing each stored facial image with respect to at least one of a corresponding facial angle, eye gaze direction, phonic sound production condition, or facial expression of the user.

16. The method of claim 11 wherein the assisting includes displaying a graphical element upon a display screen to inform the user of at least one of a direction of an eye gaze and a direction of a facial angle.

17. The method of claim 11 wherein the user input comprises at least one of a manual input and a spoken command.

18. A method of generating an animated self-portrait from self-portrait photographs stored in a facial image database, the method comprising:
detecting an event within a computer environment;
selecting a simulated facial behavior in response to the detected event;
determining an image sequence in to be displayed accordance with the selected simulated facial behavior;
accessing a particular plurality of self-portrait photographs from the image database in accordance with the determined image sequence, the accessing being performed based at least in part on index information associated with each of the particular plurality of self-portrait photographs, the index information indicating at least one of a designated facial angle, a designated eye gaze direction, a designated eye condition, a designated mouth condition, a designated phonic condition, and a designated facial expression; and
displaying the particular plurality of self-portrait photographs in rapid succession and in accordance with the determined image sequence so as to produce an animated depiction of the user's face performing the selected simulated facial behavior.

19. The method of claim 18 wherein the detected event is a detected receipt of at least one of an Instant Message, a telephone call, an email, and a received user input.

20. The method of claim 18 wherein the detected event is an interaction with a web page.

21. The method of claim 18 wherein the detected event is at least one of an award of points or credits, a debit of points or credits, an output of music, an output of computer generated vocalizations, the display of a user prompt, the display of an error message, and the display of a graphical window.

22. The method of claim 18 wherein the selected simulated facial behavior is one of a simulated look around behavior, simulated yawn behavior, simulated roving eyes behavior, simulated nodding behavior, simulated head shake behavior, simulated talking behavior, simulated singing behavior, and simulated laughing behavior.

23. The method of claim 18 wherein the speed of the displayed simulated facial behavior is modulated by the processor by varying a duration for which one or more of the particular plurality of self-portrait photos are displayed.

24. The method of claim 18 wherein the selected simulated facial behavior is at least one of a real-time gaze following and a real-time facial direction following behavior in which the animated depiction of the user appears to vary the direction that the animated depiction is looking so as to follow the changing position of at least one displayed object upon a display screen.

25. The method of claim 18 wherein the selected simulated facial behavior is at least one of a real-time gaze following and a real-time facial direction following behavior in which the animated depiction of the user appears to vary the direction that animated depiction is looking so as to follow the changing position of at least one object detected by the camera.

26. The method of claim 18 wherein the animated self-portrait performs a simulated yawn behavior in response to a period of user inactivity.

27. The method of claim 18 wherein the animated self-portrait shakes its head back and forth to indicate that a user action is not allowed.

28. The method of claim 18 wherein the animated self-portrait nods its head up and down to indicate that a user action is allowed.

29. The method of claim 18 wherein the animated self-portrait moves its mouth along with computer generated vocalizations.

30. The method of claim 18 wherein the animated self-portrait looks towards a prompt that requires user attention.

31. The method of claim 18 wherein the animated self portrait nods affirmatively in response to a user input or query.
